(19) United States
(12) Patent Application Publication
(10) Pub. No.: US 2016/0223066 A1
(43) Pub. Date: Aug. 4, 2016

(54) RACK GUIDE MECHANISM

(71) Applicant: Showa Corporation, Gyoda-shi (JP)

(72) Inventor: Atsushi IMAMURA, Haga-gun (JP)

(73) Assignee: Showa Corporation, Gyoda-shi (JP)

(21) Appl. No.: 14/854,589

(22) Filed: Sep. 15, 2015

(30) Foreign Application Priority Data
Jan. 30, 2015 (JP) 2015-016911

(51) Int. Cl. F16H 55/28; B62D 3/12

(52) U.S. Cl. CPC F16H 55/283; B62D 3/123

(57) ABSTRACT

A rack guide mechanism includes: a housing; a rack guide housed in the housing so as to move freely, supporting a rack shaft; a lid member attached to the housing; and an elastic member interposed between the rack guide and the lid member, biasing the rack guide to the rack shaft, in which the elastic member includes a first elastic portion constantly sandwiched between the rack guide and the lid member, and a second elastic portion sandwiched between the rack guide and the lid member when the rack guide moves to the lid member side by a given distance, and the first elastic portion and the second elastic portion are integrally formed.

### CROSS-REFERENCE TO RELATED APPLICATIONS

This application is based on and claims priority under 35 USC 119 from Japanese Patent Application No. 2015-016911 filed on Jan. 30, 2015, the entire content of which is incorporated herein by reference.

### BACKGROUND

1. Technical Field

The present invention relates to a rack guide mechanism.

2. Related Art

There is a rack and pinion type steering apparatus which includes a housing, a pinion shaft provided with a pinion gear, to which an operation force of a steering wheel is transmitted, a rack shaft provided with a rack gear engaged with the pinion gear and a rack guide mechanism guiding a moving direction of the rack shaft and biasing the rack shaft to the pinion shaft by an elastic restoring force (for example, refer to JP-A-2002-370654 (Patent Literature 1)).

The rack guide mechanism includes a rack guide provided to the housing so as to slide, a screw (lid member) screwed to the housing, and a compression coil spring provided between the rack guide and the screw, biasing the rack guide so that the rack shaft is constantly pressed onto the pinion shaft. As the rack shaft is pressed and biased to the pinion shaft, backlash between the pinion gear and the rack gear can be reduced and the operation force of the steering wheel can be positively transmitted to the rack shaft.

When a large external force is added to the rack shaft, the rack shaft may be largely separated from the pinion shaft. As a method of restoring from the separation state smoothly, a method of increasing an elastic force (spring rate) of a compression coil spring can be considered. However, as the force of pressing and biasing the rack guide to the rack shaft is constantly strong in this method, there is a problem that the sliding resistance of the rack shaft is increased and the steering feeling is liable to be deteriorated.

In response to the above, a technique in which a disc spring is interposed between the rack guide and the screw in addition to the compression coil spring is known. FIG. 4 is an explanatory view of the above, and a numeral 51 denotes a pinion shaft, a numeral 52 denotes a rack shaft, a numeral 53 denotes a rack guide, a numeral 54 is a screw, a numeral 55 denotes a compression coil spring, a numeral 56 denotes a disc spring and a numeral 57 denotes a housing. A female screw 58 is formed in the housing 57, and a male screw 59 of the screw 54 is screwed into the female screw 58. In the structure of FIG. 4, the rack guide 53 is biased only by the elastic restoring force of the compression coil spring 55 in a normal state or in a range in which a relatively small external force acts on the rack shaft 52. Then, when the pinion shaft 51 is largely separated from the rack shaft 52 as the large external force acts on the rack shaft 52, the elastic restoring force of the disc spring 56 is allowed to act on the rack guide 53 in addition to the elastic restoring force of the compression coil spring 55. Accordingly, both the securement of good steering feeling in the normal state and the smooth restoration of engagement between the pinion shaft 51 and the rack shaft 52 in an emergency are realized.

However, the number of parts is increased in the structure of using the disc spring 56 in addition to the compression coil spring 55, which arises a problem that an assembly work of the rack guide mechanism is complicated.

Moreover, as a height dimension of the disc spring 56 is small, a stroke of a compression amount of the disc spring 56, namely, an adjustment stroke of a screwing amount of the screw 54 becomes small, which arises a problem that it is difficult to perform the initial setting of the compression amount of the disc spring 56.

Furthermore, there is a danger that an outer edge of the disc spring 56 is caught by the female screw 58 at the time of assembly and the disc screw 56 is not sandwiched by the rack guide 53 and the screw 54 correctly.

### SUMMARY OF INVENTION

An illustrative aspect of the present invention is to provide a rack guide mechanism capable of realizing both the securement of good steering feeling in the normal state and the smooth restoration of engagement between the pinion shaft and the rack shaft in an emergency by using a single elastic member.

According to an embodiment of the present invention, there is provided a rack guide mechanism including: a housing; a rack guide housed in the housing so as to move freely, supporting a rack shaft; a lid member attached to the housing; and an elastic member interposed between the rack guide and the lid member, biasing the rack guide to the rack shaft, in which the elastic member includes a first elastic portion constantly sandwiched between the rack guide and the lid member, and a second elastic portion sandwiched between the rack guide and the lid member when the rack guide moves to the lid member side by a given distance, and the first elastic portion and the second elastic portion are integrally formed.

With the configuration of the rack guide mechanism, only an elastic restoring force of the first elastic portion acts on the rack guide in the normal state or when a small external force acts on the rack shaft. Accordingly, the rack shaft slides smoothly on a sliding surface of the rack guide without a large load and good steering feeling can be obtained. In an emergency when a large external force acts on the rack shaft, both the elastic restoring force of the first elastic portion and the elastic restoring force of the second elastic portion act on the rack guide. Accordingly, the rack shaft largely separated from the pinion shaft can be returned to the pinion shaft side immediately.

As the first elastic portion and the second elastic portion can be integrally formed, an assembly work of the rack guide mechanism is facilitated without the increase in the number of parts.

The rack guide mechanism may have a configuration in which the first elastic portion is formed of a tubular cylindrical portion formed so that both ends of the tubular cylindrical portion open, the first elastic portion is housed in a housing hole of the rack guide, an axial direction of the tubular cylindrical portion is parallel to a moving direction of the rack guide, the second elastic portion is formed of a flange portion extended in an outward radial direction at one of the ends of the first elastic portion, and a gap is formed between the rack guide and the flange portion in a normal state.

With this configuration of the rack guide mechanism, the shape of the elastic member and the layout structure can be simplified. As it is not necessary to use a disc spring as in the related art, a disadvantage in which an outer edge of the disc spring is caught by a female screw of the housing does not occur.

The rack guide mechanism may have a configuration in which a liquid body may be interposed between an inner peripheral surface of the housing hole and an outer peripheral surface of the tubular cylindrical portion.

With this configuration of the rack guide mechanism, the liquid body is interposed between the inner peripheral surface of the housing hole and the outer peripheral surface of the cylindrical portion, therefore, the sliding resistance between them can be reduced and it is possible to prevent the cylindrical portion from being twisted when housed in the housing hole.

According to the rack guide mechanism discussed above, both the securement of good steering feeling in the normal state and the smooth restoration of engagement between the pinion shaft and the rack shaft in an emergency can be realized by the single elastic member, therefore, the assembly property of the rack guide mechanism can be improved without the increase in the number of parts.

### BRIEF DESCRIPTION OF DRAWINGS

FIG. 1 is a schematic structural view of a motor-driven power steering apparatus;

FIG. 2 is a cross-sectional view showing a structure of a rack guide mechanism according to the present invention;

FIG. 3 is a cross-sectional view showing the structure of the rack guide mechanism according to the present invention, in which a second elastic portion is sandwiched between a rack guide and a screw; and

FIG. 4 is a cross-sectional view showing a structure of a related-art rack guide mechanism.

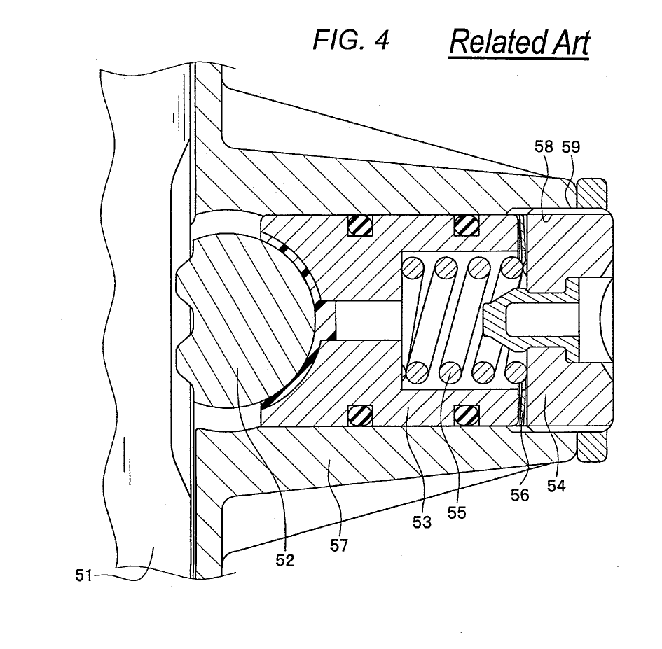

### DESCRIPTION OF EMBODIMENTS

An embodiment of the present invention will be explained with reference to the drawings. The embodiment will be explained by citing an example in which a rack guide mechanism of the present invention is applied to a motor-driven power steering apparatus, however, the present invention is not limited to this and may be applied to a hydraulic power steering apparatus and a manual steering apparatus.

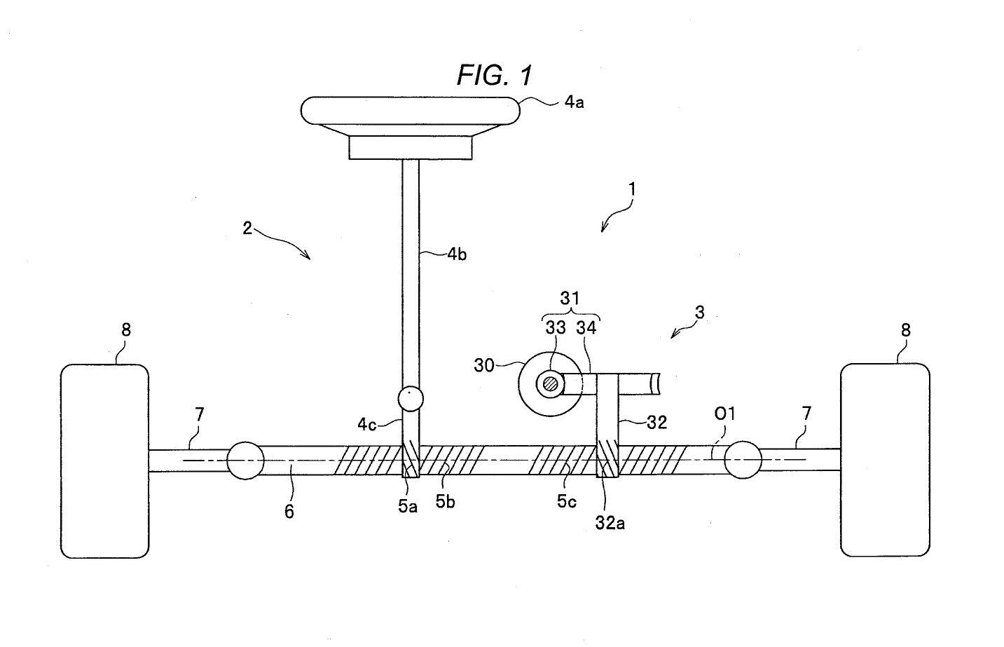

As shown in FIG. 1, a motor-driven power steering apparatus 1 is a rack and assist type apparatus including a steering mechanism 2 having a rack shaft 6 in which two rack gears which are a rack gear (steering wheel side) 5b and a rack gear (assist side) 5c are formed along a shaft center O1 and an auxiliary torque mechanism 3 giving an auxiliary steering force to the rack shaft 6.

The steering mechanism 2 includes a steering wheel 4a operated by a driver, a steering shaft 4b rotating by the operation of the steering wheel 4a, a pinion shaft 4c provided on a lower side of the steering shaft 4b through a not-shown torsion bar and a rack shaft 6 to which right and left steered wheels 8, 8 are connected on both ends through tie rods 7, 7. A pinion gear (steering wheel side) 5a of the pinion shaft 4c is engaged with the rack gear (steering wheel side) 5b of the rack shaft 6. When the driver rotates the steering wheel 4a, the rack shaft 6 moves in right and left directions to steer right and left steered wheels 8, 8.

The auxiliary torque mechanism 3 includes a motor for assistance 30, a worm gear mechanism 31 and an assist shaft 32 provided with a pinion gear (assist side) 32a, in which the pinion gear (assist side) 32a of the assist shaft 32 is engaged with the rack gear (assist side) 5c of the rack shaft 6. The worm gear mechanism 31 includes a worm 33 rotatably attached to the motor for assistance 30 and a worm wheel 34 engaged with the worm 33. The worm wheel 34 is rotatably attached to the assist shaft 32. In the auxiliary torque mechanism 3, a torque added to the steering wheel 4a is detected by a not-shown torque sensor, and the motor for assistance 30 is driven and controlled by a not-shown control device in accordance with the detected torque. Accordingly, the generated torque of the motor for assistance 30 is transmitted to the rack shaft 6 as an auxiliary steering force through the worm gear mechanism 31 and the assist shaft 32.

### “Rack Guide Mechanism 10”

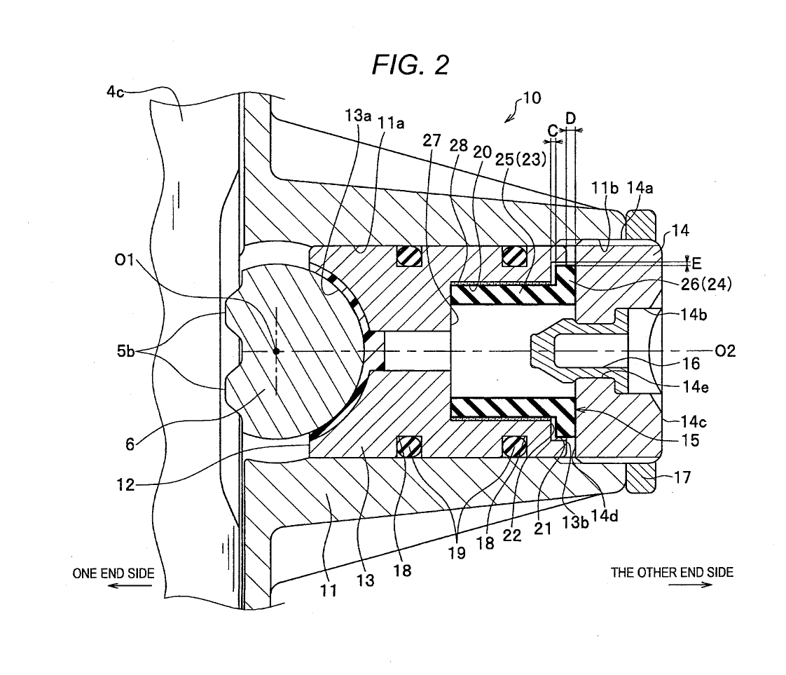

The motor-driven power steering apparatus 1 is provided with a rack guide mechanism 10 as shown in FIG. 2 for reducing backlash between the pinion gear 5a and the rack gear 5b. The rack guide mechanism 10 according to the present invention can be also applied to the pinion gear 32a and the rack gear 5c in the auxiliary torque mechanism 3.

The rack guide mechanism 10 includes a housing 11 in which a housing chamber 12 opening toward the rack shaft 6 is formed, a rack guide 13 housed in the housing chamber 12 of the housing 11 so as to move freely and supporting the rack shaft 6, a screw (lid member) 14 screwed to the housing 11 and forming a bottom wall of the housing chamber 12 and an elastic member 15 interposed between the rack guide 13 and the screw 14, biasing the rack guide 13 to the rack shaft 6.

### “Housing 11”

The housing 11 is a casing member housing various components such as the pinion shaft 4c and the rack shaft 6. The housing chamber 12 is formed as an approximately columnar through hole linearly extending from the housing position of the rack shaft 6 toward the opposite side of the pinion shaft 4c along a shaft center O2. When a portion where the rack shaft 6 is housed is referred to as one end side of the housing chamber 12 and a portion opening toward the outside of the housing 11 is referred to as the other end side of the housing chamber 12, a female screw 11b into which the screw 14 is screwed is formed on an inner peripheral surface 11a of the housing 11 on the other end side of the housing chamber 12.

### “Screw 14”

The screw 14 is an approximately short columnar member, which closes the other end side of the housing chamber 12 by screwing a male screw 14a formed on an outer peripheral surface into the female screw 11b. In an outer surface 14c of the screw 14, a tool hole 14b having a polygonal shape for inserting a rotating tool of the screw 14 is formed. Also in the screw 14, a through hole 14e piercing in the shaft center O2 direction is formed. The through hole 14e is a hole for allowing a gauge head for measuring a pressing force of the rack shaft 6 to pass through after screwing the screw 14. The through hole 14e is closed by a bush 16 afterward. After the screw 14 is screwed to the housing 11, a lock nut 17 is screwed to the male screw 14a.

### “Rack Guide 13”

A rack guide 13 is a member having an approximately columnar shape. The rack guide 13 is housed in the housing chamber 12 so as to move freely along the shaft center O2 direction in a state where an outer peripheral surface thereof faces the inner peripheral surface 11 a of the housing 11. A pair of annular grooves 18 extending in a circumferential direction is formed on the outer peripheral surface of the rack guide 13, and O-rings 19 sliding on the inner peripheral surface 11 a are fitted to respective grooves 18.

An end surface of the rack guide 13 is formed as a sliding surface 13a on which the rack shaft 6 slides in the shaft center O2 direction, which is formed to have an approximately arc shape along the outer peripheral surface of the rack shaft 6. On the other end surface 13b of the rack guide 13, a housing hole (hereinafter referred to as a cylindrical portion housing hole) 20 for housing a later-described cylindrical portion 25 and a flange portion housing hole 21 formed to have a larger diameter than an inner diameter of the cylindrical portion housing hole 20 and for housing a later-described flange portion 26 are formed in order from the rack shaft 6 side around the shaft center O2. An annular stepped surface 22 is formed between the cylindrical portion housing hole 20 and the flange portion housing hole 21.

### “Elastic Member 15”

The elastic member 15 includes a first elastic portion 23 constantly sandwiched by the rack guide 13 and the screw 14 and a second elastic portion 24 sandwiched by the rack guide 13 and the screw 14 when the rack guide 13 moves to the screw 14 side by a given distance, which are integrally formed. In the embodiment, the first elastic portion 23 is formed as a tubular cylindrical portion 25 formed so that both ends of the tubular cylindrical portion 25 open, and the first elastic portion 23 is housed in the cylindrical portion housing hole 20 of the rack guide 13. Here, an axial direction of the tubular cylindrical portion 25 is parallel to the moving direction of the rack guide 13. In the embodiment, the axial direction is the same as the moving direction (shaft center O2 direction) of the rack guide 13. The second elastic portion 24 is formed as the flange portion 26 extending in the whole circumference in an outward radial direction at the end (on the other end side) of the first elastic portion 23. A material of the elastic member 15 is, for example, a rubber material, a resin material and so on.

The cylindrical portion 25 abuts on a hole bottom surface 27 of the cylindrical portion housing hole 20 at one end surface thereof and abuts on an inner surface 14d of the screw 14 at the other end surface thereof, which is housed in the cylindrical portion housing hole 20 in a state of being constantly compressed in the shaft center O2 direction. Accordingly, the elastic restoring force of the cylindrical portion 25 constantly acts on the rack guide 13, and the rack guide 13 is in a state of being constantly pressed onto the rack shaft 6 side.

In the normal state (a large external force is not added to the rack shaft 6 and the pinion gear 5a and the rack gear 5b are normally engaged), a gap C is set between the stepped surface 22 of the rack guide 13 and the flange portion 26. The gap C is set to be smaller than a gap D between the other end surface 13b of the rack guide 13 and the inner surface 14d of the screw 14. An outer diameter of the flange portion 26 is set to be slightly smaller than an inner diameter of the flange portion housing hole 21 so that a gap E is formed between an outer peripheral surface of the flange portion 26 and an inner peripheral surface of the flange portion housing hole 21.

A liquid body 28 is interposed between the inner peripheral surface of the cylindrical portion housing hole 20 and the outer peripheral surface of the cylindrical portion 25. The liquid body 28 is applied to, for example, the outer peripheral surface of the cylindrical portion 25 in advance in a stage before the cylindrical portion 25 is housed.

### “Operation”

As shown in FIG. 2, in the normal state, or when an external force is added to the rack shaft 6, the flange portion 26 is not elastically deformed as there exists the gap C between the stepped surface 22 and the flange portion 26 in a state where the pinion gear 5a is slightly separated from the rack gear 5b within a range in which the stepped surface 22 of the rack guide 13 does not abut on the flange portion 26. Accordingly, only the elastic restoring force of the cylindrical portion 25 acts on the rack guide 13, which presses the rack guide 13 onto the rack shaft 6 side.

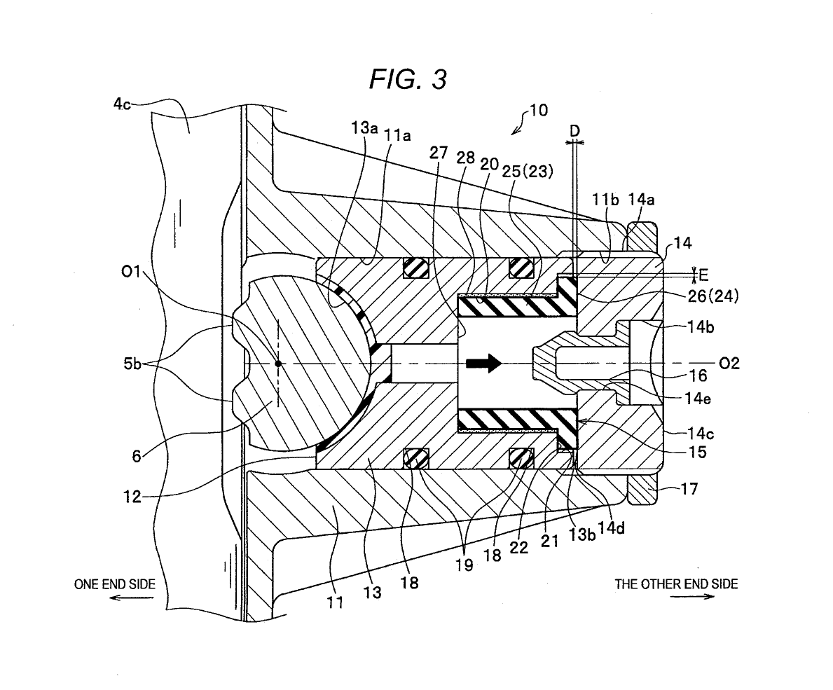

When a large external force is added to the rack shaft 6 and the pinion gear 5a is largely separated from the rack gear 5b against the biasing force of the cylindrical portion 25, the stepped surface 22 of the rack guide 13 abuts on the flange portion 26, and the flange portion 26 is sandwiched between the rack guide 13 and the screw 14 so as to be compressed in the shaft center O2 direction as shown in FIG. 3. Accordingly, the elastic restoring force of the flange portion 26 acts on the rack guide 13 in addition to the elastic restoring force of the cylindrical portion 25, which presses the rack guide 13 onto the rack shaft 6 side with the large elastic restoring force. An elastic deformation amount of the flange portion 26 in an outward radial direction can be effectively released to the gap E formed between the outer peripheral surface of the flange portion 26 and the inner peripheral surface of the flange portion housing hole 21.

As described above, when the elastic member 15 is configured to have the first elastic portion 23 constantly sandwiched by the rack guide 13 and the screw 14 and the second elastic portion 24 sandwiched by the rack guide 13 and the screw 14 when the rack guide 13 moves to the screw 14 side by a given distance, the following advantages can be obtained.

In the normal state or when a small external force is added to the rack shaft 6, only the elastic restoring force of the first elastic portion 23 acts on the rack guide 13. Therefore, the rack shaft 6 smoothly slides on the sliding surface 13a of the rack guide 13 without a large load, and good steering feeling can be obtained. In an emergency when the large external force is added to the rack shaft 6, the rack shaft 6 largely separated from the pinion shaft 4c can be returned to the pinion shaft 4c side smoothly by allowing both the elastic restoring force of the first elastic portion 23 and the elastic restoring force of the second elastic portion 24 to act on the rack guide 13.

Then, the first elastic portion 23 and the second elastic portion 24 are integrally formed, thereby suppressing the increase in the number of parts as well as facilitating the assembly work of the rack guide mechanism 10.

Moreover, the first elastic portion 23 is formed by the cylindrical portion 25, the second elastic portion 24 is formed by the flange portion 26 and the gap C is set between the rack guide 13 and the flange portion 26 in the normal state, thereby simplifying the shape of the elastic member 15 and the layout structure. As it is not necessary to use the disc spring as in the related art, a disadvantage in which the outer edge of the disc spring is caught by the female screw 11b does not occur.

When the liquid body 28 (for example, oil and fat such as grease) is interposed between the inner peripheral surface of the cylindrical portion housing hole 20 and the outer peripheral surface of the cylindrical portion 25, the following advantages can be obtained. When the screw 14 is screwed to the housing 11, the elastic member 15 is co-rotated as the other end of the elastic member 15 is fixed by pressure to the inner surface 14d of the screw 14. At that time, there is a danger that the cylindrical portion 25 is rubbed on the inner peripheral surface of the cylindrical portion housing hole 20 and is twisted. In response to this, when the liquid body 28 is interposed between the inner peripheral surface of the cylindrical portion housing hole 20 and the outer peripheral surface of the cylindrical portion 25, the rotational resistance generated in the cylindrical portion 25 can be reduced and generation of twisting of the cylindrical portion 25 can be prevented.

What is claimed is:

1. A rack guide mechanism comprising:
a housing;
a rack guide housed in the housing so as to move freely, supporting a rack shaft;
a lid member attached to the housing; and
an elastic member interposed between the rack guide and the lid member, biasing the rack guide to the rack shaft,
wherein the elastic member includes
a first elastic portion constantly sandwiched between the rack guide and the lid member, and
a second elastic portion sandwiched between the rack guide and the lid member when the rack guide moves to the lid member side by a given distance, and
the first elastic portion and the second elastic portion are integrally formed.

2. The rack guide mechanism according to claim 1,
wherein the first elastic portion is formed of a tubular cylindrical portion formed so that both ends of the tubular cylindrical portion open,
the first elastic portion is housed in a housing hole of the rack guide,
an axial direction of the tubular cylindrical portion is parallel to a moving direction of the rack guide,
the second elastic portion is formed of a flange portion extended in an outward radial direction at one of the ends of the first elastic portion, and
a gap is formed between the rack guide and the flange portion in a normal state.

3. The rack guide mechanism according to claim 2,
wherein a liquid body is interposed between an inner peripheral surface of the housing hole and an outer peripheral surface of the tubular cylindrical portion.
